(19) United States
(12) Patent Application Publication
(10) Pub. No.: US 2012/0104196 A1
(43) Pub. Date: May 3, 2012

(54) Quick Release, Adjustable Bow and Arrow Holder for a Tree Stand

(76) Inventor: Nick Regina, Seaford, NY (US)

(21) Appl. No.: 13/280,567

(22) Filed: Oct. 25, 2011

Related U.S. Application Data
(60) Provisional application No. 61/455,769, filed on Oct. 26, 2010.

(51) Int. Cl. A01M 31/00; F16M 13/02

(52) U.S. Cl. 248/205.1

(57) ABSTRACT

An adjustable holder for a hunter's tree stand provides support for various bow sizes. The holder may comprise: a mounting plate; a bow support arm pivotally attached to the mounting plate to be moveable in discrete increments; a locking plate being slidably mounted in relation to the support arm; a biasing member to bias the locking plate relative to the bow support arm and releasably engage slots located in the mounting plate to provide the incremental movement; and upper and lower bow retaining members, To provide vertical adjustability, an extendable arm is provided and telescopes outward from the bow support aim, and upon which is mounted the upper bow retaining member. Further adjustability is accomplished with the lower bow support member, which may comprise a shaft with a knob disposed upon one end, being pivotally secured to a crank arm that is then pivotally secured to the bow support aim.

This application claims priority on U.S. Provisional Patent Application Ser. No. 61/455,769, filed Oct. 26, 2010.

### FIELD OF THE INVENTION

The present invention relates to improvements in bow and arrow holders for use by a hunter in a tree stand, and more particularly to such apparatus which are capable of providing adjustments permitting adaptability for the particular equipment used by a hunter on a given day.

### BACKGROUND OF THE INVENTION

Tree stands are commonly used by hunters, and are commonly available along with hunting and sports equipment. The tree stand serves to place the hunter in an elevated position, where he or she may have a relatively unobstructed field of view of an area through which game animals tends to forage and generally travel. The elevated position also serves to lessen the advantage these animals have in visibly detecting the hunter, or in detecting the hunter's scent to become alerted to his or her presence. These tree stands tend to be light-weight and portable, thereby permitting the hunter to change locations during the course of a day of hunting.

There are many different styles of tree stands on the market; however, a typical tree stand comprises an upper support member upon which the hunter may sit, as well as a lower support member for the hunter to place his or her feet upon. The upper and lower support members are generally connected by a frame, which also may be used to at least partially encircle a tree trunk, to thereby releasably secure the stand to the tree.

It is a common practice for a hunter to sit perched in the tree stand and wait for significant periods of time for the opportunity to take a shot at passing game, and many hunters today consider it more sporting to hunt with a bow and arrow, rather than a semi-automatic rifle. During this period of waiting, it is very cumbersome and tedious for the hunter to hold the bow and arrow at the ready. Therefore, there have been a number of devices developed to aid the hunter by providing support on the tree stand for the hunter' bow.

For example, U.S. Pat. No. 5,465,933 to Todd is for a holder being releasably coupled to a tree stand. The Todd invention uses a pair of U-shaped brackets being secured to the tree stand using bolts, to thereby slidably receive the bow. The bow is then secured within the U-shaped brackets using a rubber strap that has hooks on each end. But the arrangement, while serving to store the bow in relation to the tree stand, fails to maintain the bow at the ready for the hunter to quickly retrieve the bow in preparation for taking a shot.

U.S. Pat. No. 5,310,150 to Fecko improves upon this readiness aspect by providing quick access to the bow; however, Fecko's device merely consists of a tubular member having one end that must be driven into the tree, and comprises a nail-like end or a threaded end. Such a means of attachment, which is not even part of the tree stand itself, hampers the portability aspect afforded the hunter by the collapsible tree stands commonly used.

The portability draw-back of the Fecko device was improved upon in U.S. Pat. No. 5,186,276 to Craig for a “Portable Hunting Tree Stand.” The Craig tree stand includes an arm protruding out from the frame to support the lower part of the bow, while the upper part of the bow is supported by another member protruding laterally from the upper portion of the tree stand frame. The bow is supported in a position for quick access by the hunter, but the tree stand does not offer any adjustability in the positioning of the bow relative to the hunter, nor does it offer adjustability for different types/sizes of bows that the hunter may be using on a particular day.

U.S. Pat. No. 4,936,415 to Williams is for a “Bow Holder for a Tree Stand,” and does offer a limited amount of adjustability. The Williams bow holder includes a pivotable arm moveable to different angular positions to be locked thereat using a threaded knob, which must be rotated to clamp upon the arm. Although the variable angular positions appear beneficial, the hunter is unlikely to utilize the infinite number of possible arm positions, and would probably only use small angular variations from the upright position. But requiring rotation of the knob to clamp upon the arm, and requiring knob counter-rotation thereafter to un-clamp to make adjustments in the arm position, is more cumbersome than necessary for a hunter in the field. The Williams bow holder furthermore does not accommodate different size bows, and also must be limited to use where the base of the tree stand comprises a plurality of rungs, and does not work where the base is a continuous member.

The attachment problem of Williams is absent in U.S. Pat. No. 4,729,363 to Skyba for an “Archer's Bow Rest for Tree Stand.” However, the Skyba bow rest offers no adjustability. The invention disclosed herein addresses each of these problems within the prior art.

### OBJECTS OF THE INVENTION

It is an object of the invention to provide a bow holder being usable on a tree stand.

It is another object of the invention to provide a bow holder that may be quickly removable with respect to mounting upon a tree stand.

It is a further object of the invention to provide a bow holder that may have an adjustable support arm being quickly and easily moveable to select positions.

It is another object of the invention to provide a bow holder with a support arm capable of being moved into a stowed position that is adjacent to a base of the tree stand.

It is also an object of the invention to provide a bow support arm being capable of adjusting in length to accommodate different sized bows.

It is yet another object of the invention to provide a bow holder that may be adjusted from more than one end of the support arm.

It is also an object of the invention to provide a bow support arm being capable supporting arrows in addition to the hunter's bow.

Further objects and advantages of the invention will become apparent from the following description and claims, and from the accompanying drawings.

### SUMMARY OF THE INVENTION

An adjustable holder for a hunter's tree stand may provide support for various bow sizes, as well as for a plurality of arrows. The adjustable bow holder may comprise: a mounting plate; a bow support arm, where the bow support arm is pivotally attached to the mounting plate to be moveable in one or more discrete increments; a locking plate being slidably mounted in relation to the support aim; a biasing member to bias the locking plate relative to the bow support arm to releasably engage at least one slot located in a portion of the mounting plate; an upper bow retaining member; and a lower bow retaining member.

The upper bow retaining member may be secured to the upper portion of the bow support arm. Where an extendable arm is provided to telescope outward from within the bow support arm to provide vertical adjustability, the upper bow retaining member may instead be secured thereto. The top of the hunter's bow may be cradled in a hook portion of the upper bow support member. To permit the bow to rest at an ergonomic position to suit the hunter seated in the tree stand, a lower bow retaining member may also be used. The lower bow support member may comprise a shaft with a knob disposed upon one end, with the shaft being secured to the bow support arm. It may be secured directly thereto using threading, or, to provide greater adjustability to the position of the bow, the lower bow support member may be pivotally secured to a crank arm that is then pivotally secured to the bow support ann. The adjustability provided by the bow and arrow holder may thus be from raising or lowering the extendable arm with the hook of the upper bow support arm moving therewith, and/or the pivotal movement of the crank-mounted shaft and knob of the lower bow support member. In addition, the locking plate engagement with the slots of the mounting plate may permit small amounts of adjustment to the bow support arm laterally from the upright position. The slots may be located to permit engagement by the plate at two horizontal position (0 and 180 degrees), the vertical position (90 degrees), and two positions being slightly offset from the vertical position (i.e., 80 and 100 degrees).

An arrow holder may be affixed to the tree stand holder to permit a plurality of arrow to be conveniently placed beside the hunter's bow. The arrow holder may be affixed to the bow support arm using adhesive, magnetism, or mechanical fasteners.

### BRIEF DESCRIPTION OF THE DRAWINGS

FIG. 1 is a front view of the quick release, adjustable bow and arrow holder of the present invention.

FIG. 2 is a side view of the bow and arrow holder of FIG. 1.

FIG. 3 is an enlarged view of the lower portion of the bow holder of FIG. 1.

FIG. 4 is an enlarged view of the lower portion of the bow holder of FIG. 2.

FIG. 5 is a front view of the bow support arm of the current invention.

FIG. 5A is an end view of the bow support arm of FIG. 5.

FIG. 6 is a side view of the bow support arm of FIG. 5.

FIG. 6A is an end view of an alternate embodiment of the bow support arm of FIG. 5.

FIG. 7 is a front view of the mounting plate of the current invention.

FIG. 8 is a side view of the mounting plate of FIG. 7.

FIG. 9 is a front view of the locking plate of the current invention.

FIG. 10 is a side view of the locking plate of FIG. 9.

FIG. 11 is a front view of the arrow holder of the present invention.

FIG. 12 is a side view of the arrow holder of FIG. 11.

FIG. 13 is a front view of the tension spring.

FIG. 14 is a front view of the upper bow retaining member in the form of a hook.

FIG. 15 is a side view of the hook of FIG. 14.

FIG. 16 is a front view of the extendable arm.

FIG. 16A is an end view of the extendable arm of FIG. 16.

FIG. 17 is a front view of the lower bow retaining member.

FIG. 18 is a rear view of the bow and arrow holder of FIG. 1.

### DETAILED DESCRIPTION OF THE INVENTION

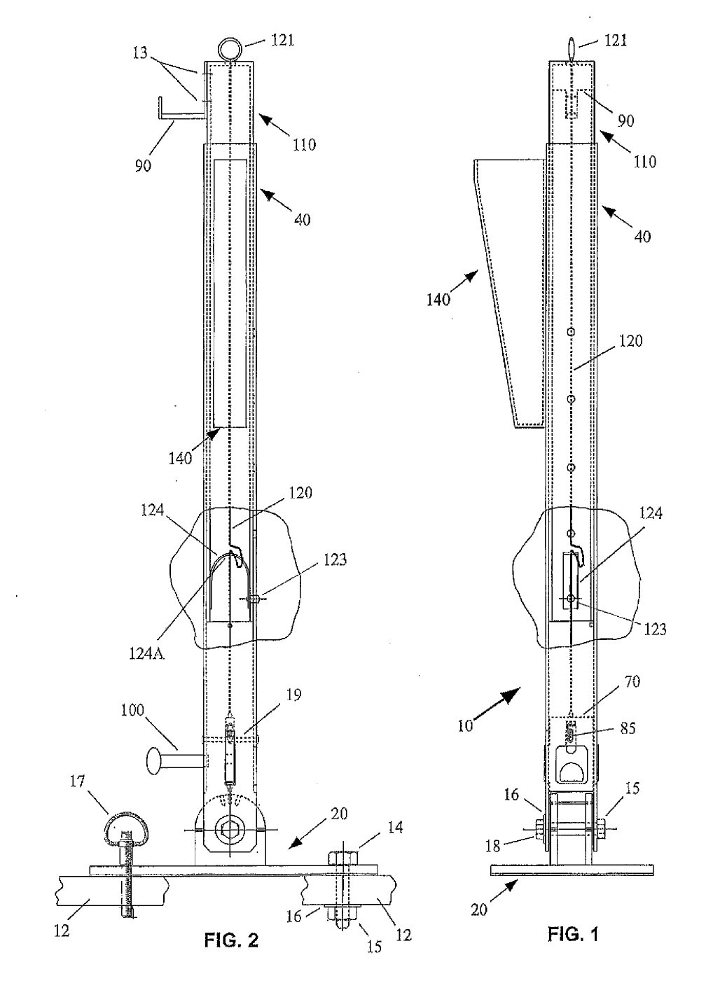

FIGS. 1 and 2 show front and side views of a first embodiment of the quick release, adjustable bow and arrow holder 10 of the present invention. The basic bow holder 10 may comprise a bow support arm 40 being pivotally attached to an arm mounting plate 20, and also a locking plate 70, a biasing member 85, an upper bow retaining member 90, and a lower bow retaining member 100. The bow support arm 40 may be pivotally mounted with respect to the plate 20 and is capable of pivoting in one or more discrete increments, as described hereinafter.

The arm mounting plate 20, as seen in FIGS. 7 and 8, may be comprised of a generally flat base plate 21, from which may protrude a first wall 22 and a second wall 23 to form a clevis. The tops of the first and second walls 22 and 23 may terminate in a full radius. The walls may be integral with the flat base plate 21, as though formed using from extrusion, or by machining a block of material, or by being separate walls that are welded thereon. Since the basic bow holder 10 need not be made of metal, and may also be manufactured of a durable plastic material, the first and second walls 22 and 23 may also be bonded thereon using adhesive. Through each wall of the clevis may be in-line holes 24. The flat base plate 21 may comprise one or more orifices 30 usable to secure the adjustable bow and arrow holder 10 of the present invention to a tree stand platform 12, using bolts, washers, and nuts (14, 15, 16), adhesive, or alternatively using quick release locking pins 17 with spring-loaded detent balls, and possibly having a ring handle for easy grasping of the pin.

Each of the first and second walls 22 and 23 of arm mounting plate 40 may have in-line sets of notches, beginning with notch set 25 to permit locking of the arm at a zero degree (first horizontal) position, notch set 26 for locking at a 90 degree angled (upright) position, notch set 27 for locking at a 180 degree angled (second horizontal) position, and notch sets 28 and 29 for locking at 80 and 100 degree positions, being just slightly angled away from the upright position. Although many other angular positions could be accommodated, these positions (0, 80, 90, 100, 180 degrees) may be preferred, as will be discussed later. The bottom of flat base plate 21 of arm mounting plate 20 may comprise a rubberized contact surface 31, which may serve to deaden the sound as the bow and arrow holder 10 are assembled onto the tree stand 12, should the hunter decide to do the assembling at the hunting site.

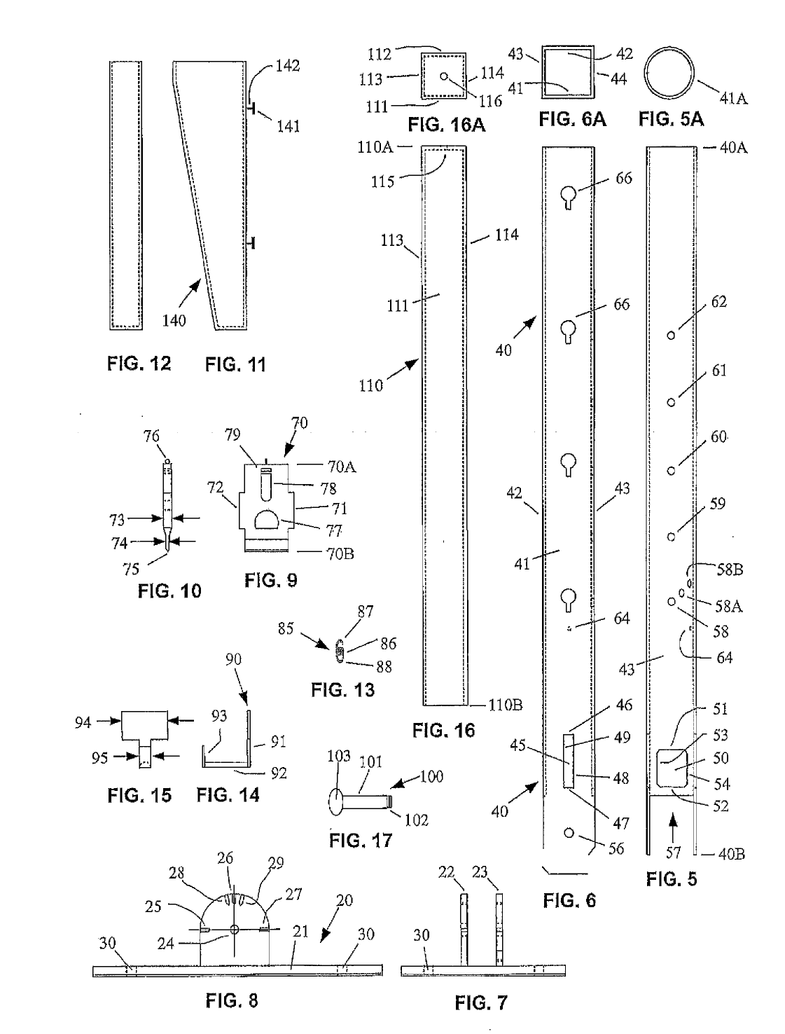

The bow support arm 40, as seen in FIGS. 5 and 6, may have an upper end 40A and a lower end 40B, and be comprised of a front wall 41, rear wall 42, first side wall 43, second side wall 44, to form a hollow member, which may have the rectangular cross-sectional shape seen in FIG. 6A. Alternatively, as seen in FIG. 5A, a circular cross-section with unitary wall 41A may instead be used, and will be discussed in more detail hereinafter. Front wall 41 and rear wall 42 may extend further than first side wall 43 and second side wall 44 at lower end 40B to form a clevis with opening 57 therebetween. Front wall 41 and rear wall 42 may have in-line orifices 56 located therein.

The bow support arm 40 may be pivotally attached to the arm mounting plate 20, using the in-line orifices 56 of the bow support arm and the in-line orifices 24 of the arm mounting plate. The pivotal connection therebetween may be by a shoulder bolt 18, to prevent deformations due to clamp-up upon the pair of devises, and by use of washers 16 and a self-locking nut 15. Other pivotal connections known in the art may also be utilized.

The front and rear walls 41 and 42 of bow support arm 40 may also comprise in-line openings 45, having upper edge boundary 46, lower edge 47, first side edge 48, and second side edge 49. There may also be an opening 50 in wall 43, having a top edge boundary 51, bottom edge 52, a first side edge 53, and a second side edge 54. The bow support arm 40 may also have a series of orifices, 58, 59, 60, 61, and 62 in one of the walls, for example wall 43, which may serve to receive a detent pin for an extendable arm discussed hereinafter.

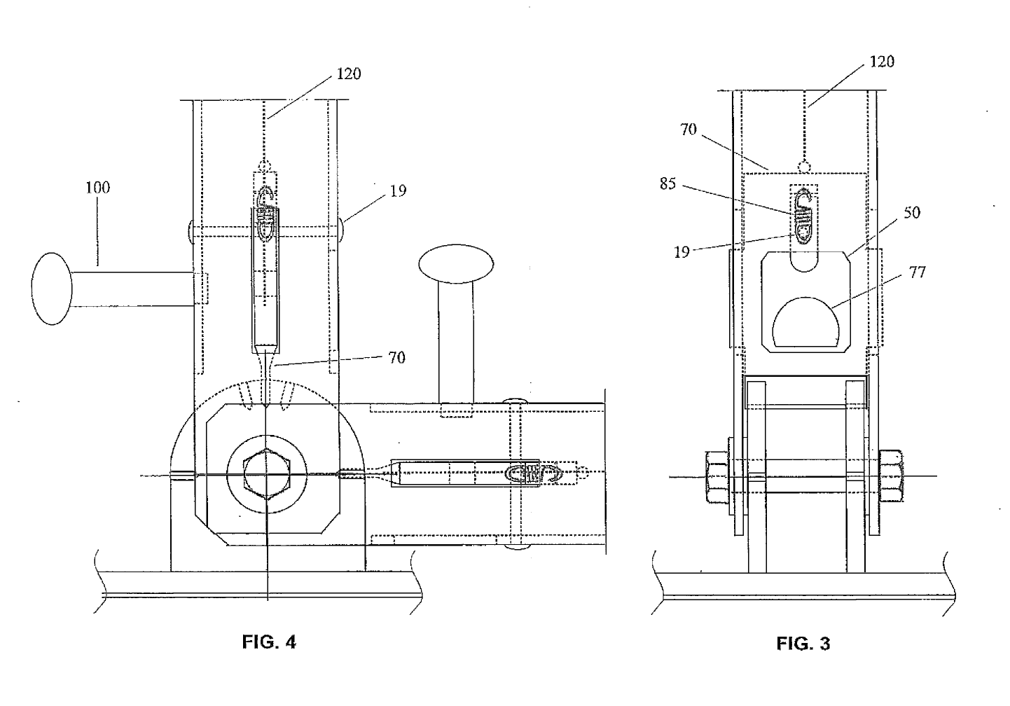

A locking plate 70 may be installed within the bow support arm 40 and be biased by a biasing member towards the first wall 22 and second wall 23 of arm mounting plate 20. The locking plate 70, best seen individually in FIGS. 9 and 10, and as installed in the enlarged views of FIGS. 3 and 4, may be comprised of a generally flat rectangular plate having an upper end 70A, a lower end 70B, and a thickness 73. The locking plate 70 may have a first side tab 71 and a second side tab 72 that may be slidably received within the in-line openings 45 of front and rear walls 41 and 42 (FIG. 3) of the bow support member. The thickness 73 may be substantial, to provide for better sliding contact within the openings 45 of the bow support arm 40, but the plate thickness may taper down to a narrower thickness 74, which may be better suited to be received by the notched sets 25, 26, 27, 28 and 29 of the first and second walls 22 and 23 of arm mounting plate 20. The narrowed thickness 74 of locking plate 70 may terminate in a V-shaped tip 75, which may serve to help in movement of the locking plate into each of the notched sets 25-29.

The locking plate 70 may be biased toward the arm mounting plate 20, so as to be releasably engaged with one of the notched sets, using a biasing member, which may be a helical tension spring 85. The spring 85, which may only comprise several coils 86 because the biasing need not be very strong, may be disposed within opening 78 of the locking plate 70, by having one end 87 of the spring 85 hook around opening 79 of the locking plate 70, and by having the other end 88 be secured relative to the bow support arm 40 using a pin 19. Pin 19 may be a pin that can have one end upset like a rivet to form a bucked head, or alternatively the pin 19 may comprise a pair of threaded members that may be threaded into each other to form the double-headed pin 19 of FIG. 4.

With this arrangement, as seen in FIGS. 4 and 5, the spring 85 may be in an un-deflected position when the end 70B of locking plate 70 is secured within one of the notched sets 25-29. When the user may desire to stow the bow support arm 40 by using the thumb-sized opening 77 of the locking plate 70, the user may insert his thumb (or other finger or even a tool) through the opening 50 of the wall 43 of the arm, and through the opening 77 of the locking plate to apply a force thereto, which may cause expansion of the spring 85 into a deflected position. This frees the engagement of the locking plate 70 with the particular notched set that had been occupied, and permits pivotal movement of the bow support arm 40 relative to the arm mounting plate 20. Once the user has moved the arm to the desired position, pressure may be released from the opening 77 of the locking plate to allow the plate to be biased back toward the arm mounting plate 20, whereby slight movements may permit the V-shaped tip 75 of the locking plate 70 to engage the notched set in the first wall 22 and a second wall 23 of the mounting plate, to inhibit further movement of the arm.

The location of the opening 77 in the locking plate 70, being disposed toward the bottom of the lower end of the bow and arrow holder 10 may make it somewhat inconvenient for some users to thereafter adjust the bow support arm 40, while seated in the tree stand. Therefore, the locking plate 70 may be provided with a loop 76, to which a flexible member 120, such a string, cord, wire, beaded chain, etc., may be attached. The flexible member 120 may be strung so as to exit the top of the bow support arm 40, and where it may be attached to a ring 121. The ring 121 may be pulled by the user seated in the tree stand, to move the locking plate 70 against the spring 85 biasing, to permit discrete movement of the arm 40 to another position.

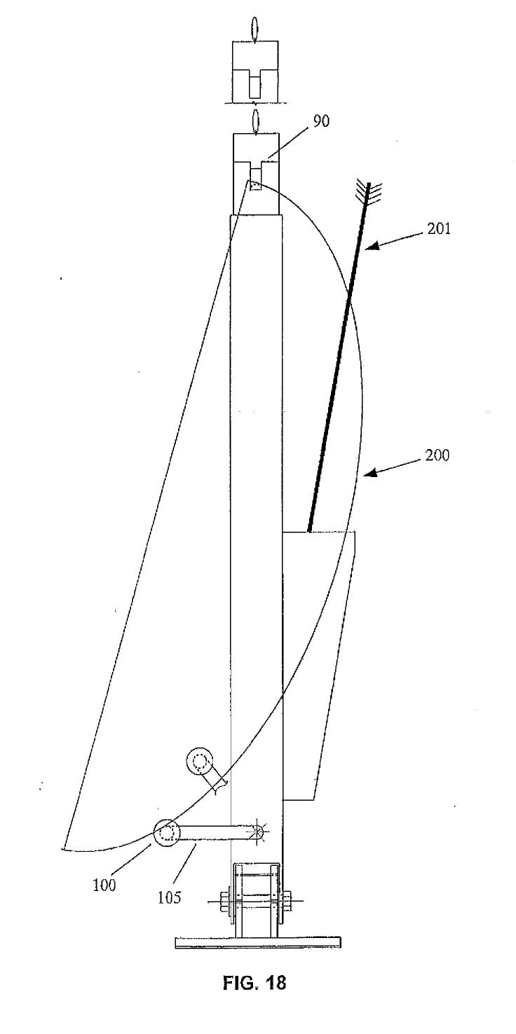

Another means of providing adjustability for the bow and arrow holder 10 of the present invention may be through the use of an extendable arm 110. As seen in detail in FIGS. 16 and 16A, the extendable arm 110 may have an upper end 110A and lower end 110B, and be comprised of a front wall 111, a rear wall 112, a first side wall 113, a second side wall 114, and an end wall 115. The extendable arm 110 may have its walls sized so as to be able to telescope out from bow support arm 40, as seen in FIGS. 1 and 2. Where an extendable arm 110 is utilized, the flexible member 120 may be strung so as to exit an orifice 116 in the top wall 115 of the extendable atm, and may furthermore be provided with excess length so as not to inhibit outward movement of the extendable arm. Inward travel of the extendable arm 110 may be limited by stop 64 on the bow support arm 40. Securing of the extendable arm 110 to the bow support arm 40, as well as providing a means of incremental movement therebetween, may be through the use of a detent pin 123 that may selectively engage the orifices 58-62 in the wall 43 of bow support arm 40. The detent pin 123 may be biased to protrude out from the walls in numerous different ways, including by directly spring loading the pin relative to the side wall of the extendable arm 110, or by using a strap 124 of flexible material bent into a U-shape, and having one end fixed to the extendable arm 110 possibly using a rivet, and having the detent pin 123 attached to the other end. There may be a generous orifice 124A in the center of the strap 124 to permit free movement of the flexible member 120 through the strap. The excess length of flexible member 120, seen draping over the strap 124 in FIGS. 1 and 2, may simply be taken up in a longer stroke when the user pulls on ring 121 to actuate the locking plate 70. The excess length should be sufficient to accommodate movement of the extendable arm 110 so as to permit engagement of the detent pin 123 with the uppermost orifice (62) of the bow support member.

Support for the hunter's bow 200 (FIG. 18) may be provided by an upper bow retaining member 90 and a lower bow retaining member 100. Where no extendable arm 110 is utilized, the upper bow retaining member 90 may be secured proximate to the end 40A of bow support arm 40. In an embodiment that utilizes extendable arm 110, the upper bow retaining member 90 may be secured proximate to the end 110A of the extendable arm 110. As seen in FIGS. 14 and 15, upper bow retaining member 90 may be comprised of an attaching wall 91, a bottom wall 92, which may have a contoured portion to serve to better retain the upper part of bow 200, and a hook wall 93. A portion of the attaching wall 91 may have a width 94 to permit mechanical fasteners, such as rivets 13, to secure the upper bow retaining member 90 to either the extendable arm 110 or the bow support arm 40, The bottom wall 92 and the hook wall 93 may have a narrower width 95 to better be able to support the bow 200.

The lower bow support member 100 may comprise a shaft 101, to which may be fixed an elliptical or a spherical knob 103. Attachment of the lower bow support member 100 may be proximate to the lower end of the bow support arm 40, according to at least one of two methods. In one embodiment, the shaft 101 may have an externally threaded portion 102, which may be threadably received within an internally threaded orifice in the bow support arm 40, as seen in FIGS. 2 and 4. In another attachment method, which provides greater adjustability as discussed hereinafter, the shaft 101 may be pivotally attached to a crank arm 105, using a rivet, or other mechanical fastening means, including a nut, washer, and bolt. The crank 105 may be pivotally attached to the lower end of the bow support arm 40 using a rivet, or more preferably using a torque-set nut and bolt, which may help to ensure a limited amount of frictional contact therebetween to serve in maintaining the crank 105 at any orientation relative to the bow support arm 40 that the user may find advantageous. Additionally, the crank 105 may be pivotally attached to the bow support arm 40 using a ratchet system to better control the pivotal positions, such as the one described in expired U.S. Pat. No. 3,986,004 to Whitney, the disclosures of which are incorporated herein by reference.

The quick release, adjustable bow and arrow holder 10 of the present invention may also include an arrow holder 140, as seen in FIGS. 11 and 12. The arrow holder may be a walled container that may be open, or may be filled with foam to retain the arrows, or may have a series of custom orifices therein to individually retain a plurality of arrows. The arrow holder 140 may be attached to the bow and arrow holder 10 by welding them together, where the component parts are made of a weldable alloy, or by using an adhesive, or by using a mechanical attachment method. A mechanical attachment method may consist of having circular disks 141 on the ends of shaft 142 that extends from a wall of arrow holder 140, which may be received in key-shaped openings 66 in the bow support arm 40.

It should be noted that the bow support arm 40 and the extendable arm 110 maybe made of tubing and thus may have the circular cross-section seen in FIG. 5A. This arrangement would further permit rotational adjustment of the extendable arm 110 and the upper bow retaining member 90 by use, as seen in FIG. 5, of orifices 58A and 58B, which may serve to retain the extendable arm 110 at various clocked positions.

The adjustability of the bow and arrow holder 10 is seen best in FIG. 18, being individually through either the vertical movement afforded by the extendable arm 110 raising the location of the upper bow retaining member 90, or by rotation of the crank 105 to reposition the lower bow support member 100. Various sized bows may also be accommodated through some combination of those two adjustment means. In addition, as stated earlier, the bow support arm 40 may be adjusted inward or outward for the convenience of the user seated on a tree stand, by release of the locking plate to permit movement to the 80 or 100 degree positions.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

We claim:

1. An adjustable bow holder for a hunter's stand, said adjustable bow holder comprising:
a mounting plate;
a bow support arm, said bow support arm being pivotally attached to said mounting plate, and being pivotable in relation thereto in one or more discrete increments;
a locking plate, said locking plate being slidably mounted in relation to said support arm;
a biasing member, said biasing member biasing said locking plate relative to said bow support arm to releasably engage at least one slot located in a portion of said mounting plate, said releasable engagement serving to inhibit pivotal motion of said bow support arm at each of said one or more discrete increments;
an upper bow retaining member; and
a lower bow retaining member.

2. The adjustable bow holder of claim 1, wherein said locking plate is released from engagement with said mounting plate by said plate being moved to counter said spring biasing.

3. The adjustable bow holder of claim 2, wherein said movement releasing said locking plate is by use of a hole in said locking plate.

4. The adjustable bow holder of claim 3, wherein said movement releasing said locking plate is through use of a flexible member having a first end secured to said locking plate, and a second end protruding from an end of said bow support arm distal to said locking plate.

5. The adjustable bow holder of claim 4 further comprising an extendable arm; and wherein said upper bow retaining member is located on said extendable arm.

6. The adjustable bow holder of claim 5, wherein said extendable arm telescopes outward from said bow support ann.

7. The adjustable bow holder of claim 6, wherein said movement of said bow support arm in discrete increments comprises approximately 90 degrees of movement from a first horizontal position to a vertical position.

8. The adjustable bow holder of claim 7, wherein said movement of said bow support arm in discrete increments further comprises approximately 90 degrees of additional movement from said vertical position to a second horizontal position.

9. The adjustable bow holder of claim 8, wherein said movement of said bow support arm in discrete increments further comprises approximately 10 degrees of movement from said vertical position towards either said first horizontal position or said second horizontal position.

10. The adjustable bow holder of claim 9, wherein said extension of said extendable arm is between two or more discrete positions, said extendable arm being secured at each of said discrete positions using a spring-loaded detent pin being received through an orifice in said extendable arm, and through at least one orifice in said bow support arm at each of said two or more discrete positions.

11. The adjustable bow holder of claim 10, wherein said upper bow support member comprises a hook member.

12. The adjustable bow holder of claim 11, wherein said lower bow support member comprises a shaft, said shaft having a knob fixed at a first end.

13. The adjustable bow holder of claim 12, wherein a second end of said shaft of said lower bow support member is mounted to said bow support aim.

14. The adjustable bow holder of claim 13, wherein said mounting of said lower bow support member is by said lower bow support member being pivotally mounted to one end of a crank arm, with a second end of said crank arm being pivotally mounted to said bow support arm.

15. The adjustable bow holder of claim 14 further comprising an arrow holder being secured to said bow support arm; and wherein said arrow holder is secured to said support arm using a securing means from the group of securing means consisting of: welding; magnetism; or mechanical fasteners.

16. The adjustable bow holder of claim 15, wherein said biasing member comprises a helical tension spring; and wherein said mounting plate being removably attachable to a tree stand comprises attachment means from the group of attaching means consisting of bolts and nuts; adhesive; or quick-release locking pins.

17. The adjustable bow holder of claim 16, wherein said mounting plate comprises a rubberized contact surface for contacting said tree stand; and wherein said flexible member for releasing said locking plate is from the group of flexible members consisting of: string, cord, wire, or beaded chain.

18. An adjustable bow holder comprising:
a mounting plate;
a bow support arm, said bow support arm having a first end and a second end, and having said second end pivotally attached to said mounting plate;
an extendable arm, said extendable arm telescoping outward from said bow support arm and being capable of movement therefrom in one or more increments of extension;
an upper bow retaining member, said upper bow retaining member being fixed to said extendable arm;
a lower bow retaining member, said lower bow retaining member being pivotally fixed to said bow support arm; said lower bow retaining member being pivotable relative to said bow support arm; and
wherein said adjustable bow holder is capable of supporting various sized bows by adjustment of one or more of: a height of said upper bow retaining member using said extendable arm; a position of lower bow retaining member by pivoting said lower bow retaining member.

19. The adjustable bow holder of claim 19 further comprising:
a locking plate, said locking plate being slidably mounted in relation to said support arm;
a biasing member, said biasing member biasing said locking plate toward said bow support arm to releasably engage at least one slot located in a portion of said mounting plate, said releasable engagement serving to inhibit pivotal motion of said bow support arm relative to said mounting plate at one or more discrete increments; and
a spring-loaded detent pin being biased to protrude out from said extendable arm to provide said one or more increments of extension, said extendable arm being secured at each of said extended positions by said spring-loaded detent pin being received through an orifice in said extendable arm, and through an orifice in said bow support arm at each of said increments of extension.

20. The adjustable bow holder of claim 19, wherein said incremental pivotal movement of said bow support arm relative to said mounting plate comprises one or more of approximately 90 degrees of movement from a first horizontal position to a vertical position; approximately 90 degrees of additional movement from said vertical position to a second horizontal position; and approximately 10 degrees of movement from said vertical position towards either said first horizontal position or said second horizontal position.
